(19) United States
(12) Patent Application Publication
(10) Pub. No.: US 2007/0139195 A1
(43) Pub. Date: Jun. 21, 2007

(54) Security system employing a hall effect sensor

(76) Inventors: Yucheng Jin, Chalfont, PA (US); John M. Coogan, Lansdale, PA (US); Jeffrey D. Ollis, Dresher, PA (US); Daniel P. Quigley, Woodinville, WA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/311,076

(22) Filed: Dec. 19, 2005

(51) Int. Cl. G08B 13/08

(52) U.S. Cl. 340/547

(57) ABSTRACT

A monitoring system includes a sensor arrangement for monitoring first and second adjacent members that are displaceable with respect to one another, The sensor includes a magnet securable to the first adjacent member and an analog magnetic transducer securable to the second adjacent member in sufficient proximity of the permanent magnet to sense a magnetic field therefrom. An analog subsystem supplies electrical power to the magnetic transducer and receives an electrical signal generated by the transducer in response to a change in the magnetic field detected by the magnetic transducer. The analog subsystem including a comparator for comparing the detected change in the magnetic field to a predefined threshold change in magnetic field and an electronic memory for storing the predefined threshold change in magnetic field.

### FIELD OF THE INVENTION

The present invention generally relates to security systems that monitor conditions within a defined environment or area, and more particularly to a security system that employs a Hall effect sensor for use on a door, window or the like.

### BACKGROUND OF THE INVENTION

Electronic security systems are becoming more common and important in residential and commercial environments. Individuals and families, in particular, desire a security system that monitors a defined premise and/or environment, to prevent or deter theft, burglary and robbery. In addition, there is a desire to monitor and detect other defined conditions and, in response to a detected condition, generate a warning. These other potentially hazardous conditions or threats include, for example, fire hazards, carbon monoxide and power failure and electricity outages.

A conventional security system for use in a home, for example, includes one or more keypads with displays and a central control panel, which in some cases is remotely located from the keypads and displays. The keypad/display allows a user to control the system. The user can use the keypad/display to “arm” or “disarm” the system in addition to selecting amongst the sensors to control. In the event of a false alarm, the homeowner may use the keypad to reset the alarm. The typical control panel includes a central microprocessor or an equivalent, which receives messages from the sensors. These messages generally indicate which of two states the sensors are in. If the system is “armed” and one or more sensor is triggered, a signal is generated and received by the control panel. The control panel circuitry activates a built-in telephone communicator to contact the proper authority, for example law enforcement, firefighting and/or health professionals, and conveys, for example, a pre-recorded message providing relevant information related to the triggered sensor. Alternatively, the telephone communicator may contact a security company monitoring the system, for example ADT, and provide information about the event which triggered the alarm condition. The security company, in turn, relays the information to the proper authority.

A number of sensors are provided for detecting various conditions and are arranged in the home or premises. The sensors are generally relatively simple devices having two operational states represented by a contact that is either in an open or closed state. For example, one common sensor includes a magnetic reed switch mounted in a door or window frame and a magnet that is carried by the adjacent door or window. The reed switch is a mechanical type switch comprised of an evacuated glass tube having a series of metal fingers disposed therein. In response to the presence of a magnetic field, the metal fingers are in mechanical contact, thus providing a signal path having a short circuit impedance characteristic between the input and output terminals of the switch. Likewise, in the absence of a magnetic field, the mechanical fingers are not in contact, thus providing a signal path having an open circuit impedance characteristic between the input and output terminals of the switch. The magnet carried by the door or window holds the reed switch in its opened or closed position (depending on whether the switch is of the normally opened or normally closed type) when the door or window is closed, and permits the reed switch to switch to its other position when the door or window is opened. The reed switch is typically interposed in an electrical circuit of a security system so that upon unauthorized opening of the door or window, the switch operation generates an alarm signal.

One problem with reed-type sensors is that they can be readily defeated by simply placing an external magnet adjacent the door or window frame in proximity to the reed switch. The external magnet holds the reed switch in its normal position and thus allows the door or window to be opened without triggering the alarm.

Another problem with reed-type switches when used in security sensors for doors or windows is that they trigger the alarm whenever the doors or windows are opened. As a result, the doors or windows cannot be placed in a partially open position so that, for example, fresh air can be allowed in. If a user does wish to leave a door or window partially open, the security system generally needs to be turned off.

### BRIEF DESCRIPTION OF THE DRAWINGS

FIG. 1 illustrates a wired security system for a residence or other premises.

FIG. 2 shows a Hall effect sensor that includes a Hall effect sensing device and a permanent magnet.

### DETAILED DESCRIPTION

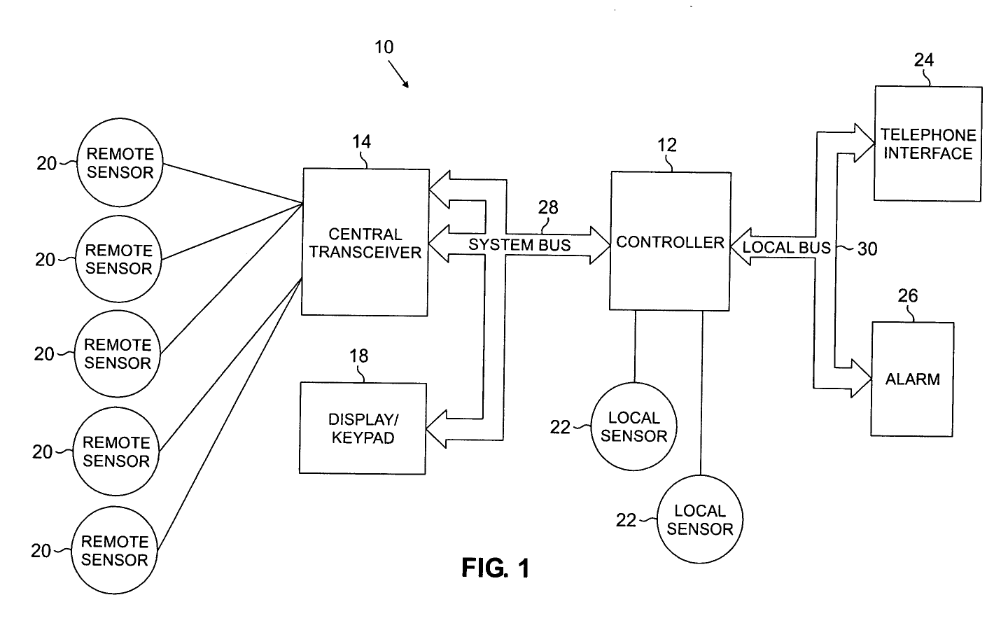

FIG. 1 illustrates a typical legacy wired security system 10. The wired security system 10 comprises a central control unit 12, a central transceiver 14 (which is some cases is incorporated in the central control unit 12), a console display/keypad 18, a plurality of remote sensors 20 and local sensors 22, a telephone dialer 24 and an alarm 26. The remote sensors 20 are hard-wired to the central transceiver 14, which communicates with the central control unit 12 via a system bus 28. The system bus 28 also links the central control unit 12 to the console display/keypad 18. System bus 28, as well as the hard wired connections between the sensors 20 and the central transceiver 14, are often simply a twisted pair conductor. Of course, the buses and other connections may have conductor configurations other than a twisted pair configuration. The central control unit 12 is connected to the telephone interface 24 (e.g., an autodialer) and the siren 26 via an auxiliary local bus 30. The central control unit 12 is also hardwired to the local sensors 22. Despite the availability of wireless capabilities (i.e., wireless communication between components, especially between the remote sensors 20 and the central control unit 12), this type of wired security system 10 still prevails in many commercial and residential applications. While FIG. 1 shows a wired security system for purposes of illustration, wireless security systems are also becoming more and more common. Such systems employ components similar to those shown in FIG. 1, except that wireless receivers, transmitters, and transceivers are also employed.

Currently available wireless security systems use any of a variety of different communication standards. For example, such systems may use, without limitation, IEEE 802.11 (e.g., 802.11a; 802.11b; 802.11g), IEEE 802.15 (e.g., 802.15.1; 802.15.3, 802.15.4), DECT, PWT, pager, PCS, Wi-Fi, Bluetooth™, cellular, and the like. While the wireless security systems, and hence wireless controllers employed in such systems, may encompass any of these standards, one particularly advantageous network protocol that is currently growing in use is ZigBee™, which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security. For these reasons ZigBee may be particularly appropriate for use in wireless security systems.

Unlike sensors conventionally employed in security systems, sensors 20 and 22 are of a type that can detect not only whether a door, window or the like is in an opened or closed state, but can also detect if the door or window is undergoing a change in state. That is, the sensors 20 and 22 can detect if the door or window undergoes a displacement by being opened or closed. The sensors 20 and 22 can also distinguish between a change in state (e.g., a door or window in the process of being opened or closed) and any stationary or fixed state in which the window or door may be in. In this way a door or window can be left partially ajar (a stationary state) without setting off an alarm, whereas if the door or window undergoes any displacement, regardless of whether it is initially in an open, closed or intermediate position, the sensor will set of the alarm. Accordingly, doors or windows can be left open (partially or fully) while the security system continues to monitor the door or window by detecting whether the door or window is displaced by being opened or closed. In contrast, as previously mentioned, conventional sensors employing reed-type switches can only detect whether the door or window is in an open or closed state.

Instead of using mechanical or reed-type switches, sensors 20 and 22 are of a type that detect a change in magnetic field strength as well as the absolute magnitude of the magnetic field. That is, the sensors operate as continuous magnetic field transducers in which an output signal is generated that is proportional to the magnetic field strength. In contrast, reed-type sensors can only detect the presence or absence of a magnetic field.

One type of analog magnetic field transducer that may be employed in the present inventor is a Hall effect sensor. The Hall effect is a well known phenomenon occurring in conductors and semiconductor materials wherein a current flowing generally perpendicular to a magnetic field induces a voltage perpendicular to both the field and current, which voltage is proportional to the product of the current and the magnetic field.

More particularly, the Hall effect output voltage is the voltage produced across opposite edges of the conductor or semiconductor when placed in a magnetic field. The basis of this effect is the Lorentz force that is exerted on the current-carrying particles in the conductor or semiconductor. This force is in a direction mutually perpendicular to the particle movement and the magnetic field direction. As a result, an output voltage occurs across the conductor or semiconductor. This output voltage has a magnitude that depends upon the magnetic field present, the Hall coefficient and the excitation current in the conductor. When the excitation current is held constant, the output voltage is proportional to the magnetic field produced by the current being sensed or measured.

Hall effect sensors generally include a sensing device that detects changes in magnetic field and a magnet. The magnet field may be generated by a permanent magnet or an electromagnet. The sensing device generally includes a constant current source, a gapped toroid core (e.g., lamination stack) and a Hall effect generator (e.g., hall plate) extending into the gap of the core. An excitation current is applied to the Hall plate via contacts positioned on opposite ends thereof. A magnet is placed in close proximity to the sensing device for providing the magnetic field that is to be sensed or detected. Generally the magnet is in a movable location (e.g., on a door or window) while the Hall sensing device is held in a stationary position (e.g., on a door or window frame), although this arrangement can be reversed.

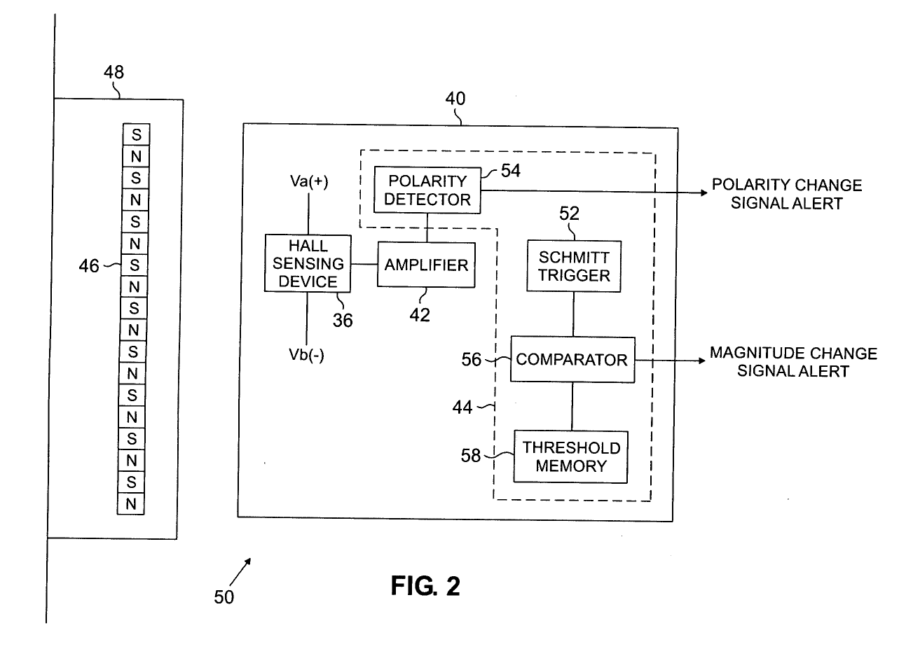

FIG. 2 shows a Hall effect sensor 50 that includes a Hall effect sensing device 36 and a permanent magnet 46. For purposes of illustration the sensing device 36 is located on a door or window frame 40. Likewise, permanent magnet 46 is located on the corresponding door or window so that the sensing device 36 and the magnet 46 are in close proximity to one another. Hall effect sensing device 36 is coupled to an amplifier 42 and appropriate additional output circuitry 44 for generating output signals. Two inputs Vₐ and V_{b} are connected to an external controller circuit board (not shown), which serves to power the sensing device 36. In some cases a battery backup may be provided for supplying electrical power to the magnetic transducer in the event of a power failure.

In operation, assuming the magnet 46 moves during operation (by opening or closing the door or window) and the sensing device 36 is stationary, the Hall effect sensing device 36 picks up variations in the magnetic flux generated by the movement of the permanent magnet 46 and sends a corresponding signal to the external controller circuit board (not shown). The external controller can then trigger an alarm, notify a central controller in the security system, and/or notify the proper authorities using a telephone interface (e.g., interface 24 in FIG. 1) incorporated in the security system.

A change in the magnetic flux that is detected by the Hall effect sensing device 36 can arise in either or two ways. First, the polarity of the detected magnetic field may change (from North to South or South to North). Alternatively, or in addition thereto, there may be a change in the magnitude or strength of the detected magnetic field. Accordingly, the output circuitry 44 that receives the amplified output signal from the Hall sensing device 36 is configured to generate an alert signal when the Hall sensing device 36 detects either a change in the magnitude of the magnetic field (above a predetermined minimum threshold) or a change in the magnetic field polarity. One particular example of such circuitry 44 that may be employed is shown in FIG. 2. As shown, a polarity detector 54 is used to detect a change in the polarity of the magnetic field detected by the Hall sensing device 36 and, in response, to generate an output signal that is used by the external controller to trigger an alarm. Likewise, a comparator 56 compares the change in magnitude of the detected magnetic field to a predefined threshold value or values stored in a memory 58. If the change exceeds the predefined threshold value, the comparator 56 generates an output signal that is also used by the external controller to trigger an alarm. A Schmitt trigger 52 may be used between the amplifier 42 and the comparator 56 in a well known manner to reduce the affects of noise by using a hysteresis detection scheme.

Hall effect sensor devices, including the associated circuitry, are commercially available from a variety of different sources. Since they have no mechanical parts, they are generally highly reliable. Also, because they are all electronic, they are suitable for miniaturization and are available in packages that are smaller than those in which reed-type sensors are housed. As a result, Hall effect sensors can be lower in cost than reed-type sensors and easier to install.

Because the Hall effect sensor devices can detect changes in magnetic field, relative displacement between the sensor and the permanent magnet will be detected, thus indicating that the window, door or the like on which the permanent magnet (or Hall effect sensor device) is secured has been moved from its initial position. In this way a partially opened door or window can still be monitored by detecting any subsequent displacement that may occur, for example, if an intruder attempts to further open the door or window.

The Hall effect sensor cannot be defeated simply by placing an external magnet near it, which as previously mentioned, is a problem that reed-type sensors suffer. If an external magnet is placed near a Hall effect sensor the sensor will detect a change in magnetic field and thus generate a signal that triggers an alarm.

The permanent magnet 46 can be configured as a block, similar to the magnet used in a reed-type switch. Alternatively, the permanent magnet 46 can be a strip magnet. More generally, the magnet can have any configuration that is desired and can be tailored for the particular application for which it will be used. This allows greater flexibility in the design and placement of the sensor and can allow the sensor to be used in a greater number of different applications. For example, instead of monitoring a defined area or premises, the sensor can be used to monitor individual objects (e.g., a valuable painting or sculpture) by detecting any displacement of that object.

Although various embodiments are specifically illustrated and described herein, it will be appreciated that modifications and variations of the present invention are covered by the above teachings and are within the purview of the appended claims without departing from the spirit and intended scope of the invention. For example, while a Hall effect sensor has been presented above, other continuous magnetic transducers also may be employed.

1. A monitoring system, comprising:
a sensor arrangement for monitoring first and second adjacent members that are displaceable with respect to one another, said sensor arrangement including;
a magnet securable to the first adjacent member;
an analog magnetic transducer securable to the second adjacent member in sufficient proximity of the permanent magnet to sense a magnetic field therefrom; and
an analog subsystem for supplying electrical power to the magnetic transducer and receiving an electrical signal generated by the transducer in response to a change in the magnetic field detected by the magnetic transducer, said analog subsystem including a comparator for comparing the detected change in the magnetic field to a predefined threshold change in magnetic field and an electronic memory for storing the predefined threshold change in magnetic field.

2. The monitoring system of claim 1 wherein the analog magnetic transducer is a Hall effect sensing device.

3. The monitoring system of claim 1 wherein said first and second adjacent members define a perimeter of an area to be monitored.

4. The monitoring system of claim 3 wherein said first adjacent member is a door or window.

5. The monitoring system of claim 1 wherein one of said first and second adjacent members is an object to be monitored.

6. The monitoring system of claim 1 wherein the analog subsystem includes a constant current source and the electrical signal that is generated is a voltage that is proportional to the detected magnetic field.

7. The monitoring system of claim 1 wherein the detected change in magnetic field is a change in polarity.

8. The monitoring system of claim 1 wherein the detected change in magnetic field is a change in magnitude.

9. The monitoring system of claim 8 wherein the predefined threshold change in magnetic field defines a minimum change in the detected magnetic field needed to generate an alert signal.

10. The monitoring system of claim 1 wherein the analog subsystem further comprises an amplifier for amplifying the received electrical signal and a Schmitt trigger for reducing noise in the received electrical signal.

11. The monitoring system of claim 1 wherein the analog subsystem further comprises a battery backup for supplying electrical power to the magnetic transducer in the event of a power failure.

12. A method for monitoring first and second adjacent members that are displaceable with respect to one another, comprising:
generating a magnetic field from the first member;
detecting a change in the magnetic field with a detector associated with the second member; and
issuing an alert signal when the change in the magnetic field exceeds a predetermined threshold.

13. The method of claim 12 wherein the predetermined threshold is a change in magnitude and/or a change in polarity of the magnetic field.

14. The method of claim 12 further comprising communicating the alert signal to a security system controller.

15. The method of claim 14 wherein the alert signal is communicated to the controller in a wireless manner.

16. The method of claim 12 wherein the detector is a Hall effect sensor.

17. The method of claim 12 further comprising issuing an alert signal when the detected magnetic field exceeds a magnitude of the magnetic field of the first member.
